(19) United States
(12) Patent Application Publication
(10) Pub. No.: US 2016/0205905 A1
(43) Pub. Date: Jul. 21, 2016

(54) CASTING NET METHOD AND APPARATUS

(71) Applicant: John Souther, Benbrook, TX (US)

(72) Inventor: John Souther, Benbrook, TX (US)

(21) Appl. No.: 14/598,066

(22) Filed: Jan. 15, 2015

(51) Int. Cl. A01K 74/00; B29C 73/04; A01K 75/00

(52) U.S. Cl. CPC A01K 74/00; A01K 75/00; B29C 73/04

(57) ABSTRACT

A casting net composed of a plurality of net sections. The net sections are coupled together with one or more attachment members. Each net section is selectively removable from other net sections. The casting net includes a lead line releasably coupled to the perimeter of the net, a yoke releasably coupled to an interior of the net, and a plurality of braille lines coupled to the lead line and passing through the yoke. A handline is included for permitting a user to apply a force to the braille lines to close and withdrawn the casting net from the water.

### BACKGROUND

1. Field of the Invention

The present application relates generally to fishing equipment and, more particularly, to an improved casting net.

2. Description of Related Art

Various types of cast nets are available in the market. Cast nets are a type of throw net used by fisherman. The nets are thrown by the fisherman onto the surface of the water where they are designed to sink in a controlled and relatively predictable manner to surround sea life. Nets are typically made from a single mesh and extend between an outer lead line and internal yoke. Snags can cause the nets to tear creating holes. Holes make the nets unusable when the type and size of sea life to be caught is smaller than the opening of the hole. Some efforts are made to repair damaged nets but are limited. Damaged nets are often thrown away.

It is desirable to provide an improved casting net to better permit repair. Although some advancements have been made, considerable shortcomings remain.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a casting net according to the preferred embodiment of the present application;

FIG. 2 is a top view of the netting of the casting net of FIG. 1; and

FIG. 3 is an exemplary top view of a portion of the casting net of FIG. 2 with net attachments.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The apparatus and method of use in accordance with the present application overcomes one or more of the above-discussed problems commonly associated with existing casting nets. Specifically, the apparatus of the present application is configured to provide a sectioned net designed to allow a user to replace portions or sections of the net and avoid the need to discard the entire net prematurely. These and other unique features of the apparatus are discussed below and illustrated in the accompanying drawings.

The apparatus will be understood, both as to its structure and operation, from the accompanying drawings, taken in conjunction with the accompanying description. Several embodiments of the apparatus are contemplated herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The apparatus of the present application includes a plurality of net sections selectively coupled together to form a net. The plurality of net sections provide a user the ability to replace selected sections of the net as the net becomes worn or damaged as opposed to completely discarding the entire net. The net sections may be coupled directly to one another or directly to a section divider configured to separate the net sections.

Referring now to the figures wherein like reference characters identify corresponding or similar elements in form and function throughout the several views. The following Figures describe casting net 101 and its associated features to provide an improved casting net. It is understood that the principles described herein are applicable to other types of nets besides those of casting nets. Therefore, casting nets are used merely for exemplary purposes in the description, but in no wise act to limit the present application to only casting nets. A net as disclosed herein may be a casting net, a net used as a shade or screen, a net acting as a boundary between two locations, and so forth.

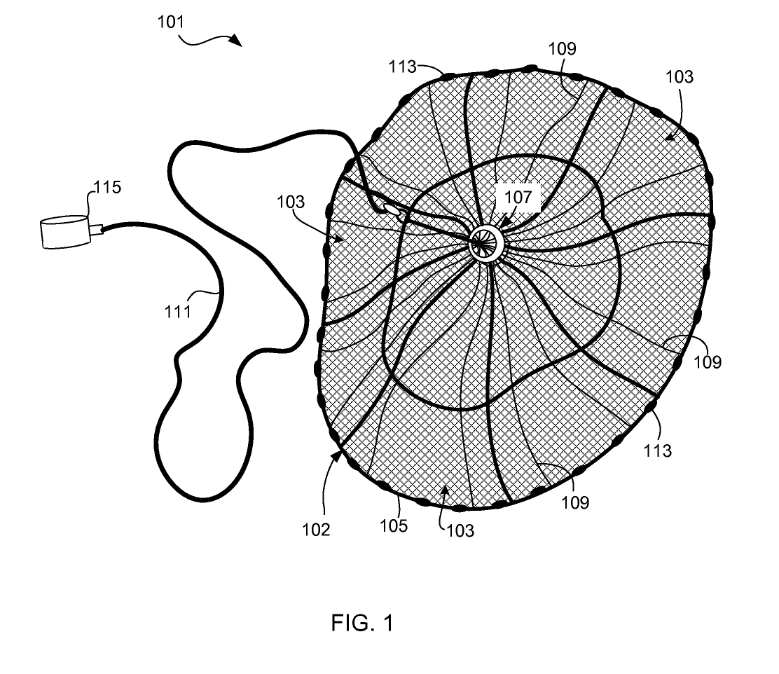

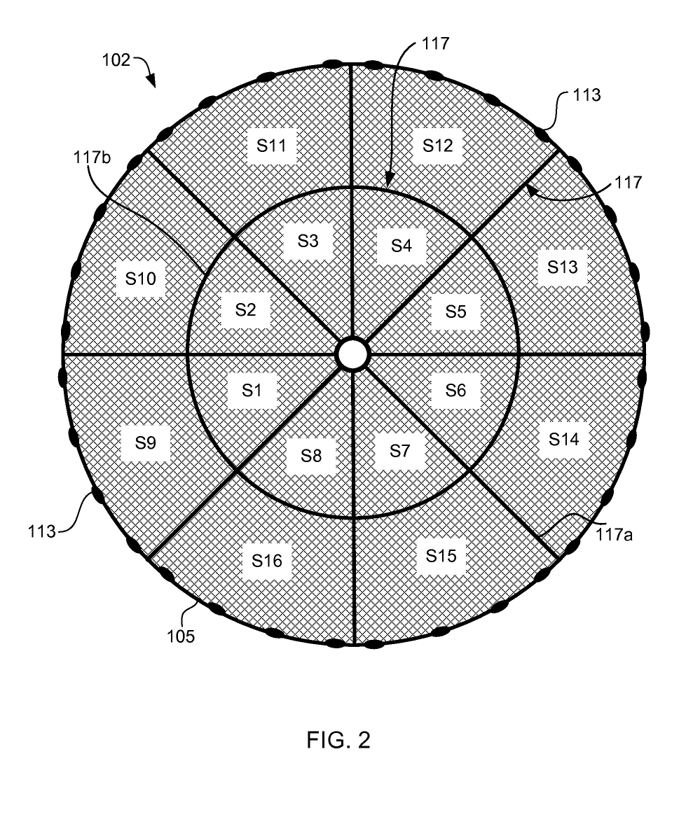

Referring now to FIG. 1 in the drawings, a casting net 101 is illustrated. Casting net 101 includes a plurality of net sections 103 (more clearly shown in FIG. 2) coupled together to form a net 102, a lead line 105 coupled to the net around the perimeter edge of the net, a yoke 107, a braille line 109, and a handline 111. Casting net 101 is configured to be thrown into water and sink below the surface at a predefined rate, having a predefined shape. A user is able to withdraw the net by pulling or applying a force to handline 111 which in turn pulls braille lines 109, such that the net closes.

Lead line 105 includes a plurality of weights 113 selectively sized and spaced along its length. The weights are configured to sink the lead line edge of the net faster in the water than the yoke portion of the net. By adjusting the weight, the edge of the net may sink at different weights. Additionally, net sections 103 have a selected mesh size. Alterations to the mesh size can have an effect upon the sinking rate of net 101.

Yoke 107 is centrally located within the net sections 103. Net sections 103 are releasably coupled to yoke 107. Braille lines 109 have are coupled at one end to lead line 105 and extend freely along a side of the net sections (lower side) and pass through yoke 107. Braille lines 109 couple to handline 111 at the other end, opposite from lead line 105. Handline 111 extends from braille lines 109 and ends with a user attachment device 115. The user applies force through device 115 and handline 111 in general to close the net. To describe the term “closing” with respect to the net, it is to be understood that the lead line 105 will sink at a faster rate than yoke 107. Therefore, the shape under water will be similar to that of a dome. Braille lines 109 travel from lead line 105 within the dome shape, such that pulling of the braille lines 109 pulls the lead line 105 inward towards yoke 107, thereby effectively closing the net 101.

Referring now also to FIG. 2 in the drawings, the net portion of net 101 is illustrated along with along with net sections 103. Net 102 includes a plurality of net sections 103. For simplicity and clarity, the net sections 103 are illustrated using a numbered “S” identifier (S1, S2, S3, S4, . . . , S16). As seen, there are 16 designated net sections 103. It is understood that various embodiments may use more or less than 16. As mentioned earlier, sections 103 have a particular mesh size. An example of mesh size may be ¼ inch, ⅜ inch, ½ inch, and ⅝ inch. Mesh sizes within net 102 may be adjusted or varied. For example, net 102 may replace all sections 113 to change mesh size. Alternatively, a user may replace only portions of net 102 such that net 102 is formed from sections 103 having different sizes simultaneously (S1 has ¼ inch mesh and S2 has ⅜ inch mesh).

Each section 103 of net 102 is configured to be removable and/or replaced. Other portions of casting net 101 are retained as sections 103 are interchanged. In one embodiment, each section 103 of net 102 is coupled directly to each other. In another embodiment, casting net 101 further includes a section divider 117 selectively located between sections 103. Sections 103 may then be attached directly to section divider 117. Use of section divider 117 allows sections 103 that are not damaged or being removed to remain fully attached as another section is removed. Section dividers 117 are illustrated for exemplary purposes in FIG. 2. It is understood that the number and orientation of section dividers 117 are adjustable depending on use and preference. In way of example, net section S11 may be detached from adjacent section dividers. In doing so, net sections S12, S3, and S10 remain coupled to adjacent section dividers 117.

Section dividers 117 are made from a similar material from that of conventional nets. For example, dividers 117 may be made from a monofilament test line. The pound rating can vary. An advantage of net 101 is that net sections 103 have a predefined shape. Replacement sections may be made and sold for the various positions. Additionally, section dividers may be relocated to generate different net section shapes, thereby allowing a user to customize a particular pattern or illustrate graphical indicia, such as a word, mark, logo, symbol, and so forth.

Two types of section dividers are illustrated. Section divider 117 may extend radially between yoke 107 and lead line 105 as seen by section divider 117a. Section divider 117a may be coupled to either yoke 107 or lead line 105, or may extend in merely a radial direction from the center of net 102 but avoid contact with either yoke 107 or lead line 105. This is not shown but can be easily visualized wherein multiple circular section dividers are used. Section divider 117 may extend circularly, such that it encircles around a portion of yoke 107, as shown with section divider 117b. When not interrupted, divider 117b may fully encircle yoke 107. The radius of divider 117b may arbitrarily be selected by a user or be predefined by a manufacturer based upon type of use or manufacturing constraints. Where a plurality of dividers 117b are used, divider 117a may extend only between such.

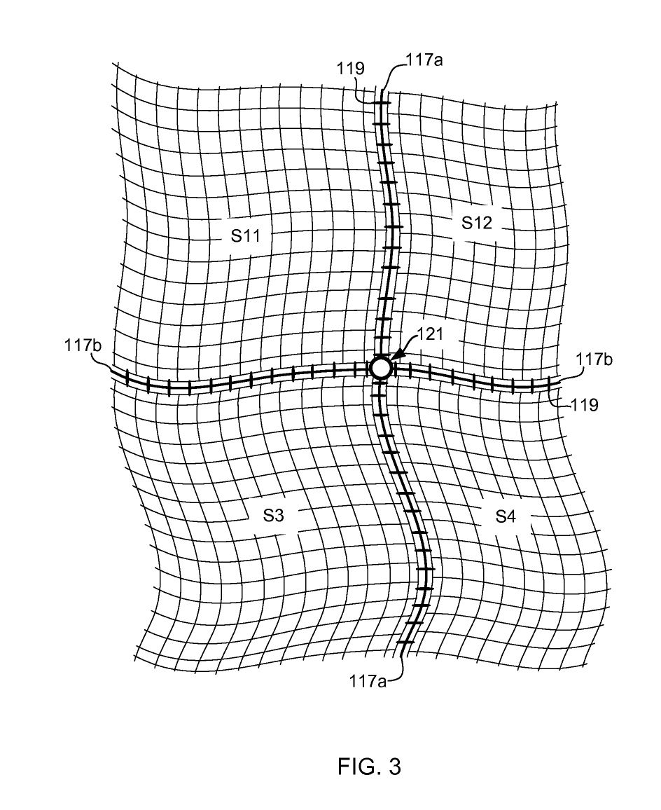

Referring now also to FIG. 3 in the drawings, an exemplary enlarged view of net 102 is illustrated. FIG. 3 shows the method of attachment of the various sections 103 to divider 117. Casting net 101 may further include the use of a joint 121. Joint 121 acts as a junction location for the attachment and passage of intersecting dividers. As shown in FIG. 3, joint 121 may interrupt both divider 117a and 117b. In other embodiments, joint 121 is configured to permit the passage of a single divider and require the other divider to be divided and attached to joint 121.

Casting net 101 further includes attachment members 119 configured to join sections 103 to one another. Members 119 may couple individual sections (i.e. S4) to a neighboring section (i.e. S5) directly. Alternatively, members 119 may couple a section 103 to divider 117. Attachment members are configured to release and recouple the plurality of net sections 103. Members 119 may be configured for single use operations, wherein the attachment member is unable to fasten section 103 a second time. Alternatively, attachment members 119 may be configured for multi-use capabilities, wherein the same attachment member may couple, release, and recouple net sections 103. An example of an attachment member may be monofilament test line as described previously. The test line would allow for the sections to be tied together. Light weight clamps, hook and loop fasteners, clips, and snaps are also considered possible examples.

The current application has many advantages over the prior art including at least the following: (1) single net containing predefined net sections; (2) ability to repair large portions of the casting net; and (3) avoidance of discarding an entire net due to damage.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A casting net, comprising:
a plurality of net sections, each section having a selectively sized mesh;
an attachment member configured to couple the plurality of net sections to form a net, the net sections being selectively separable from one another;
a lead line releasably coupled to the perimeter of the net;
a yoke releasably coupled to an interior of the net;
a plurality of braille lines having a first end and a second end, the first end coupled to the lead line, the plurality of braille lines passing through the yoke; and
a handline coupled to the second end of the braille lines and configured to provide a user the ability to close the net by applying a force to the lead line.

2. The casting net of claim 1, wherein the mesh is at least one of ¼ inch, ⅜ inch, ½ inch, and ⅝ inch in size.

3. The casting net of claim 1, wherein the mesh size may vary between the plurality of joined sections.

4. The casting net of claim 1, wherein each section of the plurality of net sections is removable and replaceable.

5. The casting net of claim 1, wherein the attachment member is configured to release and recouple the plurality of net sections.

6. The casting net of claim 1, wherein the attachment member is configured for a single use operation.

7. The casting net of claim 1, wherein the attachment member couples a first section directly to a second section of the net.

8. The casting net of claim 1, further comprising:
a section divider configured to separate the plurality of net sections between the lead line and the yoke.

9. The casting net of claim 8, wherein the attachment member couples a first net section directly to the section divider.

10. The casting net of claim 8, wherein the section divider extends radially between the yoke and lead line.

11. The casting net of claim 10, wherein the section divider is coupled to at least one of the yoke and the lead line.

12. The casting net of claim 10, wherein the section divider avoids contact with the yoke and the lead line.

13. The casting net of claim 8, wherein the section divider encircles the yoke.

14. The casting net of claim 8, wherein the plurality of joined sections of net are tied together.

15. A method of repairing a net; comprising:
obtaining the net, the net formed from a plurality of predefined net sections coupled together;
detaching a first net section from the plurality of net sections;
replacing the first net section with a second net section; and
attaching the second net section to the remaining plurality of net sections.

16. The method of claim 15, wherein the plurality of predefined net sections are separated by a section divider.

17. The method of claim 15, wherein the plurality of predefined net sections are releasably coupled with an attachment member.
